(19) United States
(12) Patent Application Publication
(10) Pub. No.: US 2026/0054116 A1
(43) Pub. Date: Feb. 26, 2026

(54) BATTERY STRUCTURE

(71) Applicant: SAMSUNG SDI CO., LTD., Yongin-Si (KR)

(72) Inventor: Jong-Wook YOON, Yongin-Si (KR)

(21) Appl. No.: 19/057,598

(22) Filed: Feb. 19, 2025

(30) Foreign Application Priority Data
Aug. 20, 2024 (KR) 10-2024-0111500

(51) Int. Cl. A62C 35/10; A62C 3/16; H01M 10/613; H01M 10/647; H01M 10/653; H01M 10/6567; H01M 50/209; H01M 50/383; H01M 50/502

(52) U.S. Cl. CPC A62C 35/10; A62C 3/16; H01M 10/613; H01M 10/647; H01M 10/653; H01M 10/6567; H01M 50/209; H01M 50/383; H01M 50/502; H01M 2200/10; H01M 2200/20

(57) ABSTRACT

A battery structure includes a frame having an accommodation space, battery cells accommodated in the accommodation space, busbars connected to the battery cells, and a heat extinguishing element above the battery cells. The heat extinguishing elements is configured to absorb heat generated by the busbars connected to the battery cells and configured to spray an extinguishing material to the battery cells in response to the heat extinguishing element being heated to a predetermined level or higher.

### CROSS REFERENCE TO RELATED APPLICATION

The present application claims priority to and the benefit of Korean Application No. 10-2024-0111500, filed on Aug. 20, 2024, in the Korean Intellectual Property Office, the entire disclosure of which is incorporated herein by reference.

### BACKGROUND

### 1. Field

The present disclosure relates to a battery structure.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Heat may be generated when a secondary battery is being discharged or charged. When the heat generation continues unabated, the secondary battery may experience thermal runaway, which may cause a fire in a device or system including or mounted to the secondary battery.

Additionally, battery cells are connected to each other by busbars, which may easily transfer heat between adjacent battery cells, thereby increasing the degree of degradation and decreasing the lifespan of the battery cells.

The above information disclosed in this Background section is for enhancement of understanding of the background of the present disclosure, and therefore, it may contain information that does not constitute related (or prior) art.

### SUMMARY

The present disclosure relates to various embodiments of a battery structure configured to prevent or at least mitigate thermal runaway.

These and other aspects and features of the present disclosure will be described in or will be apparent from the following description of embodiments of the present disclosure.

According to one or more embodiments of the present disclosure, a battery structure may include a frame having an accommodation space, battery cells accommodated in the accommodation space, busbars connected to the battery cells, and a heat extinguishing element above the battery cells. The heat extinguishing elements is configured to absorb heat generated by the busbars connected to the battery cells and to spray an extinguishing material to the battery cells in response to being heated to a predetermined level (temperature) or higher.

In some embodiments, the heat extinguishing element may include a housing having an extinguishing material stored therein, and nozzles on a first surface of the housing opposite the battery cells and configured to be opened to spray the extinguishing material in response to an internal pressure of the housing being at a predetermined level (pressure) or greater.

In some embodiments, the housing may be on the busbars and may include a thermal conductivity plastic material to absorb heat generated by the busbars.

In some embodiments, the extinguishing material may include a fire extinguishing agent that expands in volume to increase the internal pressure of the housing in response to being heated by heat transferred thereto.

In some embodiments, the nozzles may be above vents of the battery cells and the nozzles may be configured to spray the extinguishing material toward the vents.

In some embodiments, a number of the nozzles may be equal to a number of the battery cells below the heat extinguishing element.

In some embodiments, the nozzles may be recessed inwardly from the first surface of the housing such that the nozzles are thinner than other regions of the housing.

In some embodiments, the nozzles may have X-shaped notched grooves on a surface opposite the vents of the battery cells and that are configured to spray the extinguishing material to the vents in response to being opened.

In some embodiments, a thickness of each of the nozzles may be selected such that the nozzles are configured to be opened at substantially a same temperature as the vents of the battery cells.

In some embodiments, the nozzles may include a material having a melting point lower than the temperature of a gas sprayed from the vents of the battery cells.

In some embodiments, the battery structure may further include tap plates on the housing that are configured to transfer heat generated by the busbars to the extinguishing material.

In some embodiments, the tap plates may be on the busbars of the battery cells.

In some embodiments, the tap plates may include a metal having a thermal conductivity substantially equal to or greater than the thermal conductivity of the busbars.

In some embodiments, the tap plates extend through the housing such that first surfaces thereof contact the extinguishing material.

In some embodiments, the extinguishing material may include a fire extinguishing agent that may be electrically non-conductive to insulate between the tap plates.

In some embodiments, the battery structure may further include insulating pads between the busbars and the tap plates to provide electrical insulation.

In some embodiments, the insulating pads may include a thermal conductivity resin to transfer heat generated by the busbars to the tap plates.

In some embodiments, each of the insulating pads may have a shape corresponding to a shape of each of the busbars.

In some embodiments, the heat extinguishing element may further include spikes each configured to be moved by a gas released from a corresponding one of the vents of the battery cells to strike and open a corresponding one of the nozzles.

In some embodiments, the housing may include spike supports protruding from the first surface and along peripheral portions of the nozzle such that the spikes may be received in the spike supports.

According to some embodiments of the present disclosure, the heat extinguishing element may be on the busbars connected to the battery cells to absorb heat generated by the busbars.

According to some embodiments of the present disclosure, the heat extinguishing element may be configured to spray an extinguishing material to extinguish a fire on the battery cells in response to the heat extinguishing element being heated to a predetermined level (temperature) or higher.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a perspective view of a battery structure according to embodiments of the present disclosure.

FIG. 2 illustrates an exploded perspective view of the battery structure according to embodiments of the present disclosure.

FIG. 3 illustrates a perspective view of a heat extinguishing element according to embodiments of the present disclosure.

FIG. 4 illustrates a cross-section taken along line A-A of FIG. 3.

FIG. 5 illustrates a cross-sectional view of the battery structure according to embodiments of the present disclosure.

FIG. 6 illustrates a cross-sectional view depicting the heat extinguishing element of the battery structure according to embodiments of the present disclosure spraying an extinguishing material.

FIG. 7 illustrates a perspective view of a heat extinguishing element according to other embodiments of the present disclosure.

FIG. 8 illustrates a cross-section taken along line B-B of FIG. 7.

FIG. 9 illustrates an exploded perspective view of a battery structure according to other embodiments of the present disclosure.

FIG. 10 illustrates a cross-sectional view of the battery structure according to other embodiments of the present disclosure.

FIG. 11 illustrates a cross-sectional view showing the heat extinguishing element of the battery structure according to other embodiments of the present disclosure spraying an extinguishing material.

FIG. 12 illustrates a cross-sectional view of a battery structure according to other embodiments of the present disclosure.

FIG. 13 illustrates a cross-sectional view showing a heat extinguishing element spraying an extinguishing material in the battery structure according to other embodiments of the present disclosure.

### DETAILED DESCRIPTION OF THE EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (or under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

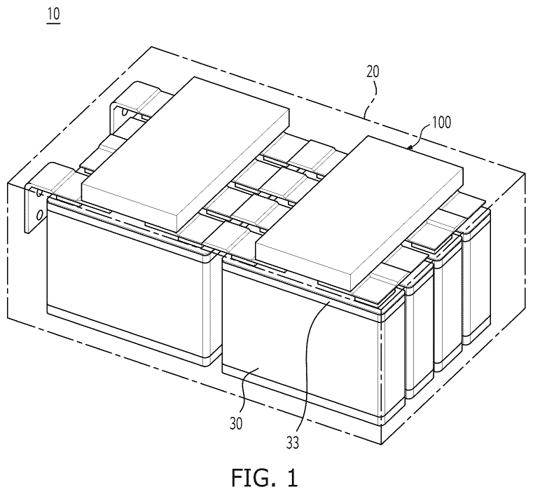

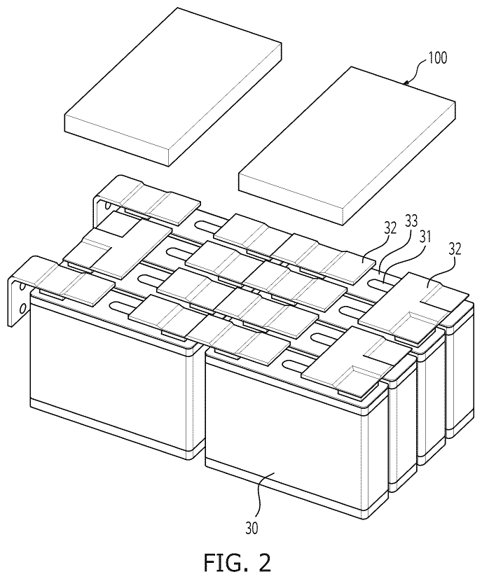

FIG. 1 is a perspective view of a battery structure according to embodiments of the present disclosure, and FIG. 2 is an exploded perspective view of the battery structure according to embodiments of the present disclosure.

Referring now to FIGS. 1 and 2, a battery structure 10 according to embodiments of the present disclosure may include a frame 20 having an accommodation space, a plurality of battery cells 30 accommodated in the accommodation space of the frame 20, and heat extinguishing elements 100 above the battery cells 30.

The battery structure 10 according to one or more embodiments of the present disclosure includes electrode units, the battery cells 30 arranged in one direction, a busbar 32 connecting a battery cell to an adjacent battery cell, and a protection circuit module having one end connected to the busbar 32. The protection circuit module may include a battery management system (BMS).

Each battery cell 30 may include a battery case, an electrode assembly received (or accommodated) in the battery case, and an electrolyte. The electrode assembly and the electrolyte react electrochemically to store and release (e.g., generate) energy. Terminal parts electrically connected to the busbar 32 and a vent 31 as a discharge passage for gas generated within the battery case may be provided on one side of (e.g., an upper side of) the battery cell 30. The terminal parts of the battery cell 30 may be a positive electrode terminal and a negative electrode terminal having different polarities from each other, and the terminal parts of the adjacent battery cells may be electrically connected to each other in series or parallel by the busbar 32, to be described in more detail below. Although a serial connection has been described as an example, the connection structure is not limited thereto, and various connection structures may be employed as desired or necessary. In addition, the number and arrangement of battery cells is not limited to the structure shown in FIG. 1 and may be changed as desired or necessary.

The battery cells 30 may be arranged in (e.g., may be stacked in) one direction so that the wide surfaces of the battery cells 30 face each other, and the battery cells 30 may be fixed by the frame 20.

The battery case may form the overall contour of the battery cell 30, and the battery case may be formed of a conductive metal such as aluminum, an aluminum alloy, or nickel-plated steel. The battery case may provide a space in which the electrode assembly is accommodated. Although the battery case is shown as a prismatic case and the battery cell 30 is shown as a prismatic battery cell, the scope of the present disclosure is not limited thereto. The battery cell 30 may be a battery cell of any shape, such as an angular, cylindrical, or pouch shape.

The cap plate 33 may be coupled to an open end of the battery case to seal the battery case. The battery case and the cap plate 33 may be formed of a conductive material. According to some embodiments, the top end of the battery case may be open, and the cap plate 33 may seal the open top end of the battery case. A positive terminal electrically connected to the positive electrode and a negative terminal electrically connected to the negative electrode may be coupled to the cap plate 33. The vent 31 may be provided on the cap plate 33. The vent 31 may be configured to be opened in response to an internal pressure in the battery cell 30 being equal to or greater than a predetermined threshold pressure.

The battery cell 30 may be a lithium battery cell, a sodium battery cell, or the like. However, the scope of the present disclosure is not limited thereto, and the battery cell 30 may include any cell capable of repeatedly providing electricity by charging and discharging. In some embodiments in which the battery cell 30 is a lithium battery cell, the battery cell 30 may be used in an electric vehicle (EV) due to the excellent life characteristics and high-rate capability of a lithium battery cell. For example, the battery cell 30 may be used in a hybrid vehicle, such as a plug-in hybrid electric vehicle (PHEV). Lithium battery cells may be used in applications requiring large amounts of power storage. For example, lithium battery cells may be used in electric bicycles, power tools, and the like.

The busbars 32 may be electrically connected to the battery cells 30. A busbar holder supporting the busbars 32 and a circuit board electrically connected to the busbars 32 and including various circuits and components may be further provided.

The negative and positive terminals provided on the cap plate 33 may be electrically connected to the busbars 32. The number and arrangement of the battery cells 30 are not limited to the structure shown in FIGS. 1 and 2 and they may be suitably modified as desired.

The busbars 32 may electrically connect the positive terminal and the negative terminal. The busbars 32 may connect the battery cells 30 in series and/or in parallel. The busbars 32 may be provided as a plurality of busbars. According to some embodiments, each of the busbars 32 may electrically connect the positive terminal of one battery cell 30 to the positive terminal or the negative terminal of another battery cell 30. Each of the busbars 32 may also electrically connect the negative terminal of one battery cell 30 to the positive terminal or the negative terminal of another battery cell 30. The busbars 32 may be connected to the positive terminal and/or the negative terminal by welding, for example. Regions of the battery cell 30 other than the positive terminal and the negative terminal may be insulated from the busbars 32 by a busbar holder. The busbars 32 may be electrically connected to a circuit board. The circuit board may be mounted with various components configured to measure status information of the battery cells 32, such as voltages and/or temperatures of the battery cells 32, and various components or circuits configured to control and/or manage the battery cells 32. The circuit board may include a battery management system (BMS).

The heat extinguishing elements 100 may be above the battery cells 30. The heat extinguishing elements 100 may be configured to absorb heat generated by the busbars 32 connected to the battery cells 30 and to spray an extinguishing material onto the battery cells 30 in response to being heated to a predetermined level (temperature) or higher. In one or more embodiments, the heat extinguishing elements 100 may be in direct contact with the busbars 32 to absorb heat generated by the busbars 32. For example, the bottom surfaces of the heat extinguishing elements 100 may be in direct contact with at least a portion of the top surfaces of the busbars 32. In one or more embodiments, the heat extinguishing elements 100 may be connected to the busbars 32 via an intervening thermal conductor to absorb heat generated by the busbars 32. The heat extinguishing elements 100 may have an extinguishing material stored or contained therein, and the stored extinguishing material may be configured to absorb and dissipate heat transferred from the busbars 32. In response to the extinguishing material of the heat extinguishing elements 100 being heated up to a predetermined level or higher by absorbing heat, the extinguishing material may be sprayed outward to extinguish the battery cells 30.

The heat extinguishing elements 100 described above may be configured to perform a heat dissipation function by absorbing heat transferred from the busbars 32 in a predetermined temperature range. In addition, in response to an event such as a thermal runaway occurring in the battery cells 30, the heat extinguishing elements 100 may extinguish the battery cells 30 by spraying the extinguishing material onto the battery cells 30.

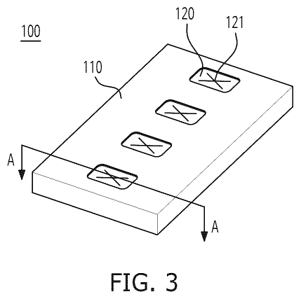

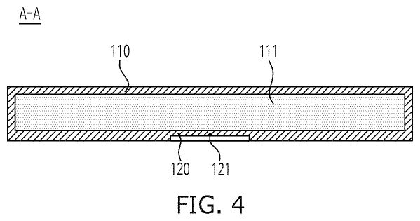

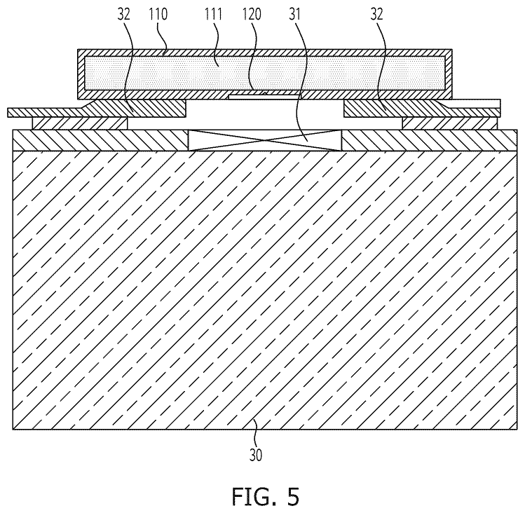

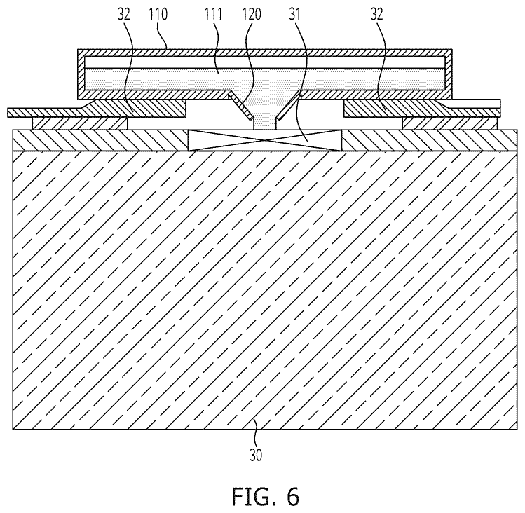

FIG. 3 illustrates a perspective view showing a heat extinguishing element according to embodiments of the present disclosure, and FIG. 4 illustrates a cross-section taken along line A-A of FIG. 3. In addition, FIG. 5 illustrates a cross-sectional view showing the battery structure according to embodiments of the present disclosure, and FIG. 6 illustrates a cross-sectional view showing the heat extinguishing element of the battery structure according to embodiments of the present disclosure spraying an extinguishing material.

Referring now to FIGS. 3 to 6, the heat extinguishing element 100 according to embodiments may include a housing 110 having an extinguishing material 111 stored or contained therein and nozzles 120 on the housing 110 that are configured to spray the extinguishing material 111.

The housing 110 may be shaped to have a cavity or chamber to store or contain the extinguishing material 111 therein. In addition, the housing 110 may be on the busbars 32 of the battery cells 30 and may be formed of a material capable of absorbing heat generated by the busbars 32.

Because the housing 110 is on the busbars 32, the housing 110 may be formed of an electrically non-conductive material to electrical insulate between the busbars 32. In addition, the housing 110 may be formed of a high thermal conductivity material to absorb heat generated by the busbars 32. In one or more embodiments, the housing 110 may be formed of a thermally conductive plastic material. The material of the housing 110 is not limited thereto and may be any material that is thermally conductive but electrically non-conductive.

The extinguishing material 111 is configured to be stored or contained within the housing 110 and to absorb heat transferred to the housing 110. In response to the busbars 32 being heated to a predetermined temperature range, the housing 110 may initially absorb heat, and the extinguishing material 111 may absorb the heat from the heated housing 110 to cool the busbars 32.

In addition, the extinguishing material 111 may include a fire extinguishing agent that expands in volume in response to being heated by heat transferred thereto. In some embodiments, the fire extinguishing agent may include a water-based agent or Novec™. The fire extinguishing agent is not limited thereto, and it may have any form or shape that may expand in volume upon heat transfer.

The extinguishing material 111 is configured to expand by receiving heat from the housing 110 to increase the pressure within the housing 110. In response to the pressure within the housing 110 increasing to a predetermined level or higher, the nozzles 120 are opened (e.g., ruptured or destroyed) to spray the extinguishing material 111 stored in the housing 110.

The nozzles 120 are provided on a first surface of the housing 110 facing the battery cell 30 and are configured to be opened (e.g., ruptured or destroyed) to spray the extinguishing material 111 in response to the pressure within the housing 110 being at a predetermined level (pressure) or higher. The nozzles 120 are above the vent 31 of the battery cell 30 such that in response to the nozzles 120 being opened (e.g., ruptured or destroyed), the extinguishing material 111 may be sprayed toward the vent 31.

In addition, the number of nozzles 120 may correspond to the number of battery cells 30 below the heat extinguishing elements 100. In one or more embodiments, the nozzles 120 may be above the vents 31 of the battery cells 30. The nozzles 120 may be opened (e.g., ruptured or destroyed) in response to the vents 31 being opened. In one or more embodiments, even when the vents 31 remain unopened (e.g., closed), the nozzles 120 may be opened (e.g., ruptured or destroyed) by the increased pressure within the housing 110 due to heat generated from the busbars 32.

In some embodiments, the nozzles 120 may be recessed inwardly from the first surface of the housing 110 such that the nozzles 120 are thinner than the other regions of the housing 110. Accordingly, in response to the pressure within the housing 110 increasing, stress may be concentrated in the relatively thin nozzles 120, thereby causing the nozzles 120 to be relatively easily destroyed.

In addition, in one or more embodiments, each of the nozzles 120 has X-shaped notched grooves 121 on the surface opposite the vent 31 of the battery cell 30 such that in response to the nozzle 120 being destroyed, the extinguishing material 111 may be sprayed to the vent 31. That is, in response to the pressure within the housing 110 increasing, the stress is concentrated in the notched grooves 121 of the nozzle 120, and the nozzle 120 may be opened (e.g., ruptured or destroyed) along the notched grooves 121. Accordingly, a point at which the nozzle 120 is configured to be ruptured or destroyed may be predetermined, thereby allowing the extinguishing material 111 to be sprayed more accurately to the vent 31.

In some embodiments, each nozzle 120 may have a thickness such that the nozzle 120 is configured to be opened (e.g., ruptured or destroyed) at the same or substantially the same temperature at which the vent 31 of the battery cell 30 is opened (i.e., the vent 31 of the battery cell 30 and the nozzles 120 of the heat extinguishing element 100 may be configured to open at the same temperature or substantially the same temperature). In response to the temperature inside the battery cell 30 increasing to a predetermined temperature or higher, the vent 31 may open to allow the gas to escape from the inside to the outside. By setting the temperature at which the vent 31 is configured to be opened and calculating the internal pressure of the housing 110 in response to being heated to the set temperature, the thickness of the nozzle 120 may be set so that the nozzle 120 may be configured to be opened (e.g., ruptured or destroyed) at the calculated pressure (or substantially at the calculated pressure). In this manner, in response to the vent 31 of the battery cell 30 being opened, the nozzle 120 may spray the extinguishing material 111 toward the vent 31 to prevent a fire from occurring.

In some embodiments, the nozzles 120 may be formed of a material having a melting point lower than the temperature of the gas sprayed to the vent 31 of the battery cell 30. In a case where the vent 31 is opened, hot gas may be blown toward the nozzle 120 to melt the nozzle 120, thereby causing the nozzles 120 to be more easily destroyed. As a result, in a case where the vent 31 of the battery cell 30 is opened, the nozzle 120 may be destroyed more quickly.

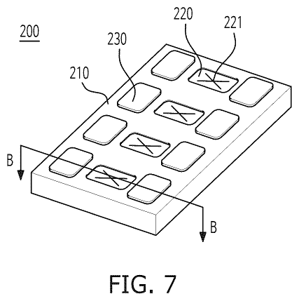

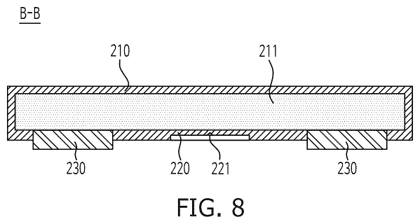

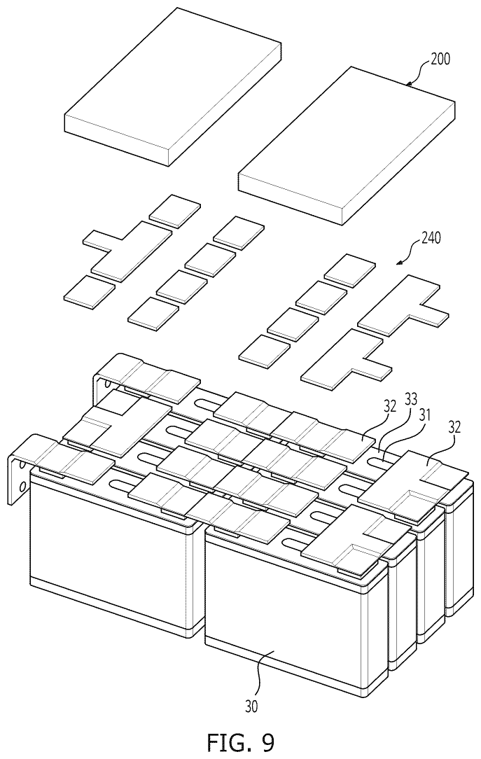

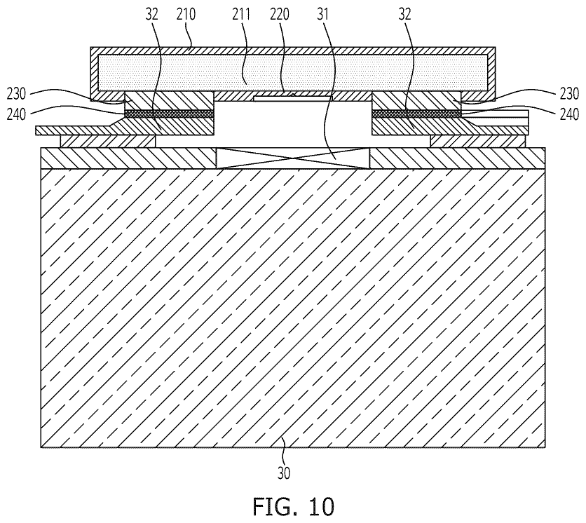

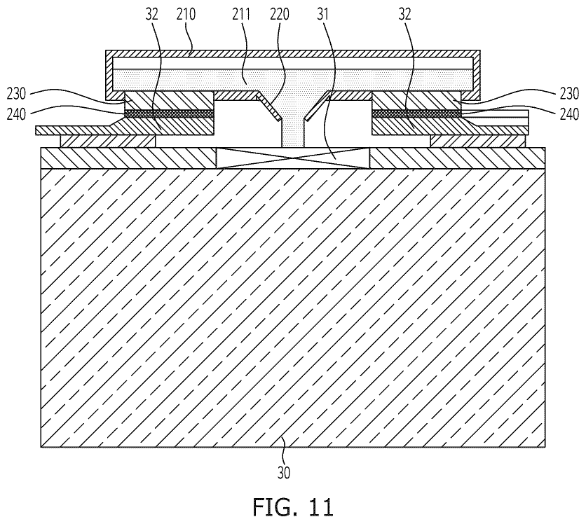

FIG. 7 illustrates a perspective view of a heat extinguishing element according to other embodiments of the present disclosure, FIG. 8 illustrates a cross-section taken along line B-B of FIG. 7, and FIG. 9 illustrates an exploded perspective view showing a battery structure according to other embodiments of the present disclosure. In addition, FIG. 10 illustrates a cross-sectional view showing the battery structure according to other embodiments of the present disclosure, and FIG. 11 illustrates a cross-sectional view showing the heat extinguishing element of the battery structure according to other embodiments of the present disclosure spraying an extinguishing material.

Referring to FIGS. 7 to 11, a heat extinguishing element 200 according to embodiments of the present disclosure may include a housing 210 having an extinguishing material 211 stored or contained therein, nozzles 220 on the housing 210 that are configured to spray the fire extinguishing material 211, and a plurality of tap plates 230 on the housing 210 that are configured to transfer heat absorbed from busbars 32 of battery cells 30 to the fire extinguishing material 211.

The housing 210 may be shaped to have a cavity or chamber to store the extinguishing material 211 therein. In addition, the housing 210 may be formed of a high thermal conductivity material such that in response to the extinguishing material 211 stored therein being heated, the housing 210 may transfer heat from the extinguishing material 211 to the outside. In one or more embodiments, the housing 210 may be formed of a thermally conductive plastic material. The material of the housing 210 is not limited thereto and may be any material that is thermally conductive but electrically non-conductive.

The extinguishing material 211 is configured to be stored or contained within the housing 210 and to absorb heat transferred to the tap plates 230 from the busbars 32. In response to the busbars 32 being heated to a predetermined temperature range, the housing 210 may initially absorb heat, and the extinguishing material 211 may absorb the heat from the heated housing 210 to cool the busbars 32.

In addition, the extinguishing material 211 may include a fire extinguishing agent that is configured to expand in volume in response to being heated by heat transferred thereto. In some embodiments, the fire extinguishing agent may include a water-based agent or Novec™. The fire extinguishing agent is not limited thereto and it may have any form or shape that is configured to expand in volume upon heat transfer.

The extinguishing material 211 expands by receiving heat from the housing 210 to increase the pressure within the housing 210. In response to the pressure within the housing 210 increasing to a predetermined level (pressure) or higher, the nozzles 220 are configured to be opened (e.g., ruptured or destroyed) to spray the extinguishing material 211 stored in the housing 210.

The nozzles 220 are on a first surface of the housing 210 facing the battery cell 30 and are configured to be opened (e.g., ruptured or destroyed) to spray the extinguishing material 211 in response to the pressure within the housing 210 being at a predetermined level (pressure) or higher. The nozzles 220 are above the vent 31 of the battery cell 30 such that in response to the nozzles 220 being opened (e.g., ruptured or destroyed), the extinguishing material 211 may be sprayed toward the vent 31.

In addition, in one or more embodiments, each of the nozzles 220 has X-shaped notched grooves 221 on the surface opposite the vent 31 of the battery cell 30, so that in response to the nozzle 220 being opened (e.g., ruptured or destroyed), the extinguishing material 211 may be sprayed to the vent 31. That is, in response to the pressure within the housing 210 increasing, stress is concentrated in the notched grooves 221 of the nozzle 220, and the nozzles 220 may be opened (e.g., ruptured or destroyed) along the notched grooves 221. Accordingly, a point at which the nozzle 220 is configured to be opened (e.g., ruptured or destroyed) may be predetermined, thereby allowing the extinguishing material 211 to be sprayed more accurately to the vent 31. The nozzles 220 may have the same configuration as the nozzles 120 described with reference to FIGS. 3 to 6.

The tap plates 230 may be adjacent to the nozzles 220 in the housing 210 and may extend through the first surface of the housing 210 such that first surfaces (e.g., upper surfaces) of the tap plates 230 contact the extinguishing material 211. In addition, each of the tap plates 230 may be configured such that a second surface thereof (e.g., a lower surface) protrudes outward from the housing 210 and is on (e.g., directly or indirectly) the busbar 32 of the battery cell 30 to absorb and transfer heat generated by the busbar 32 to the extinguishing material 211. To achieve this configuration, the tap plates 230 may be formed integrally with the housing 210 such that the tap plates 230 extend through the first surface of the housing 210 by insert injection molding.

In addition, because the tap plates 230 are configured to contact the busbars 32 and transfer heat generated by the busbars 32 to the extinguishing material 211, the tap plates 230 may be formed of a metal having a thermal conductivity substantially equal to or greater than the thermal conductivity of the busbars 32. In some embodiments, the tap plates 230 may be formed of a high thermal conductivity metal, such as copper or aluminum. The material of the tap plates 230 is not limited to the metal and may be any material having a high thermal conductivity.

The tap plates 230 may be on the busbars 32 of the battery cells 30. In some embodiments, as shown in FIG. 9, eight tap plates 230 may be on the housing 210 in an embodiment in which the heat extinguishing element 200 is provided on four battery cells 30. The number of the tap plates 230 is not limited thereto, and two tap plates may be provided on opposite sides of the nozzles 220 and extending lengthwise in the same direction to contact a plurality of busbars. The tap plates 230 may be configured in any shape and number as long as the tap plates 230 are configured to contact the busbars 32 of the battery cells 30.

In some embodiments in which the tap plates 230 are formed of a material such as an electrically conductive metal, the extinguishing material 211 may include a fire extinguishing agent that is electrically non-conductive. The tap plates 230 may be in contact with the busbars 32 of the battery cells 30 outside the housing 210 and in contact with the extinguishing material 211 within the housing 210. Accordingly, an internal short circuit may otherwise occur if the extinguishing material 211 were electrically conductive. Accordingly, the extinguishing material 211 may include a fire extinguishing agent, such as Novec™, which is electrically non-conductive.

In some embodiments, insulating pads 240 may be provided between the tap plates 230 and the busbars 32 to electrically insulate between the tap plates 230 and the busbars 32. In such an embodiment, the extinguishing material 211 may include an electrically conductive fire extinguishing agent. In addition, the insulating pads 240 may be formed of a thermally conductive resin configured to transfer heat generated by the busbars 32 to the tap plates 230. That is, because the insulating pads 240 are configured to electrically insulate between the tap plates 230 and the busbars 32 and to transfer heat generated by the busbars 32 to the tap plates 230, the insulating pads 240 may be formed of a thermally conductive resin. The material of the insulating pads 240 is not limited thereto and they may be any material that is thermally conductive but electrically non-conductive.

In addition, the insulating pads 240 may be provided in a shape corresponding (or substantially corresponding) to the shape of the busbars 32, as shown in FIG. 9. The insulating pads 240 may be on the top surfaces of the busbars 32 to cover the busbars 32 such that the busbars 32 are not exposed to the outside. The shape of the insulating pads 240 is not limited thereto and they may be any shape that may insulate between the tap plates 230 and the busbars 32.

In one or more embodiments, each of the insulating pads 240 may be in the form of a gel pad having adhesive properties. As a result, the insulating pads 240 may prevent or at least mitigate the tap plates 230 from being detached from between the tap plates 230 and the busbars 32. In addition, the insulating pads 240 may be used to attach the tap plates 230 to the busbars 32 such that the tap plates 230 are fixed in position over the busbars 32.

With this configuration, heat generated by the busbars 32 may be transferred through the insulating pads 240 to the tap plates 230, which in turn may transfer heat to the extinguishing material 211 stored or contained in the housing 210 to cool the battery cells 30.

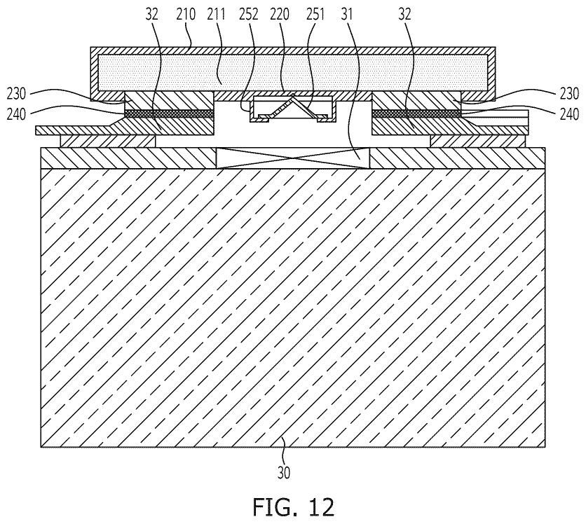

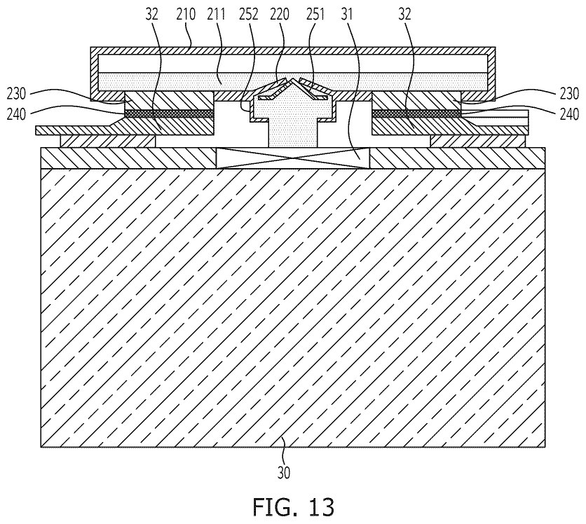

FIG. 12 illustrates a cross-sectional view showing a battery structure according to other embodiments of the present disclosure, and FIG. 13 illustrates a cross-sectional view showing a heat extinguishing element spraying an extinguishing material in the battery structure according to embodiments of the present disclosure.

Referring now to FIGS. 12 and 13, the battery structure according to embodiments of the present disclosure may further include spikes 251 in the configuration of the heat extinguishing element 200 described with reference to FIGS. 7 to 11.

Each of the spikes 251 may be configured to be moved by gas released from the vent 31 of the battery cell 30 to strike and destroy the nozzle 220. In some embodiments, the spikes 251 may be configured in the shape of a cone with a pointed end protruding upward. In response to high-pressure gas being ejected through the vent 31, the pressure of the gas ejection may cause the spike 251 to move toward the nozzle 220 (e.g., upward), so that the pointed end of the spike 251 may strike and destroy the nozzle 220. With this configuration, in response to an event such as a thermal runaway occurring, the vent 31 may be opened to release gas, thereby causing the spike 251 to strike the nozzle 220 to spray the extinguishing material 211 toward the vent 31. At this time, due to heat generated by the busbars 32 and transferred through the tap plates 230, the extinguishing material 211 stored in the housing 210 has expanded, and the pressure within the housing 210 has increased. Accordingly, in an embodiment in which the spike 251 strikes the nozzle 220, the nozzle 220 may be more easily opened (ruptured or destroyed).

In some embodiments, the housing 210 may include spike supports 252 protruding from the first surface (e.g., the lower surface) and along the peripheral portions of the nozzle 220 such that the spikes 251 are received in the spike supports 252. The spike 251 may be spaced apart by a predetermined distance from the nozzle 220 and received in the spike support 252. In this state, in response to gas being sprayed through the vent 31, the spike 251 may move along the spike support 252 and strike the nozzle 220. That is, the spike support 252 may be configured to guide the movement of the spike 251 to more accurately strike the nozzle 220. The housing 210 may also be configured such that the spike support 252 is not provided and the spike 251 is positioned above the vent 31.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

Description of Reference Symbols

| | |
|---|---|
| 10: battery structure | 20: frame |
| 30: battery cell | 31: vent |
| 32: busbar | 33: cap plate |
| 100, 200: heat extinguishing element | 110, 210: housing |
| 111, 211: extinguishing material | 120, 220: nozzle |
| 230: tap plate | 240: insulating pad |
| 251: spike | 252: spike support |

What is claimed is:

1. A battery structure comprising:
a frame comprising an accommodation space;
a plurality of battery cells accommodated in the accommodation space;
a plurality of busbars connected to the plurality of battery cells; and
a heat extinguishing element above the plurality of battery cells, wherein the heat extinguishing element is configured to absorb heat generated by the plurality of busbars connected to the battery cells and to spray an extinguishing material onto the plurality of battery cells in response to being heated to a predetermined temperature or higher.

2. The battery structure as claimed in claim 1, wherein the heat extinguishing element comprises:
a housing comprising an extinguishing material stored therein; and
a plurality of nozzles on a first surface of the housing opposite the battery cells, the plurality of nozzles being configured to be opened to spray the extinguishing material in response to an internal pressure of the housing being at a predetermined level or greater.

3. The battery structure as claimed in claim 2, wherein the housing is on the plurality of busbars and comprises a thermal conductivity plastic material configured to absorb heat generated by the plurality of busbars.

4. The battery structure as claimed in claim 2, wherein the extinguishing material comprises a fire extinguishing agent configured to expand in volume to increase the internal pressure of the housing in response to being heated by heat transferred to the housing.

5. The battery structure as claimed in claim 2, wherein the plurality of nozzles are above a plurality of vents of the plurality of battery cells, and wherein the plurality of nozzles are configured to spray the extinguishing material toward the plurality of vents.

6. The battery structure as claimed in claim 2, wherein a number of the plurality of nozzles corresponds to a number of the plurality of battery cells below the heat extinguishing element.

7. The battery structure as claimed in claim 2, wherein the plurality of nozzles are recessed inwardly from the first surface of the housing such that the plurality of nozzles are thinner than other regions of the housing.

8. The battery structure as claimed in claim 2, wherein the plurality of nozzles comprises a plurality of X-shaped notched grooves on a surface of the housing opposite a plurality of vents of the plurality of battery cells, and wherein the plurality of X-shaped notched grooves are configured to spray the extinguishing material to the plurality of vents in response to being opened.

9. The battery structure as claimed in claim 2, wherein a thickness of each of the plurality of nozzles is selected such that the plurality of nozzles are configured to open at substantially a same temperature as a plurality of vents of the plurality of battery cells.

10. The battery structure as claimed in claim 2, wherein each of the plurality of nozzles comprises a material having a melting point lower than a temperature of a gas sprayed from a plurality of vents of the plurality of battery cells.

11. The battery structure as claimed in claim 2, further comprising a plurality of tap plates on the housing, the plurality of tap plates being configured to transfer heat generated by the plurality of busbars to the extinguishing material.

12. The battery structure as claimed in claim 11, wherein the plurality of tap plates are on the plurality of busbars of the plurality of battery cells.

13. The battery structure as claimed in claim 11, wherein each of the plurality of tap plates comprises a metal having a thermal conductivity substantially equal to or greater than a thermal conductivity of the plurality of busbars.

14. The battery structure as claimed in claim 11, wherein the plurality of tap plates extends through the housing such that first surfaces of the plurality of tap plates contact the extinguishing material.

15. The battery structure as claimed in claim 14, wherein the extinguishing material comprises a fire extinguishing agent that is electrically non-conductive, the fire extinguishing agent insulating between the plurality of tap plates.

16. The battery structure as claimed in claim 11, further comprising a plurality of insulating pads between the plurality of busbars and the plurality of tap plates, the plurality of insulating pads providing electrical insulation.

17. The battery structure as claimed in claim 16, wherein each of the plurality of insulating pads comprises a thermal conductivity resin configured to transfer heat generated by the plurality of busbars to the plurality of tap plates.

18. The battery structure as claimed in claim 16, wherein each of the plurality of insulating pads has a shape corresponding to a shape of each of the plurality of busbars.

19. The battery structure as claimed in claim 2, wherein the heat extinguishing element further comprises spikes each configured to be moved by a gas released from a corresponding one of the plurality of vents of the plurality of battery cells to strike and open a corresponding one of the plurality of nozzles.

20. The battery structure as claimed in claim 19, wherein the housing further comprises a plurality of spike supports protruding from the first surface and along peripheral portions of the plurality of nozzles, and wherein the plurality of spikes are received in the plurality of spike supports.
